(19) United States
(12) Patent Application Publication
(10) Pub. No.: US 2006/0165029 A1
(43) Pub. Date: Jul. 27, 2006

(54) Protecting real-time data in wireless networks

(75) Inventors: Diego Melpignano, Monza (IT); David Siorpaes, Cortina D'Ampezzo (IT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,365

(22) PCT Filed: Nov. 20, 2003
(86) PCT No.: PCT/IB03/05345

§ 371 Date: Jun. 15, 2005

(30) Foreign Application Priority Data
Dec. 19, 2002 (EP) 02080374.8

(51) Int. Cl. H04Q 7/00

(52) U.S. Cl. 370/328

(57) ABSTRACT

The invention provides a traffic shaper module allocates more bandwidth to real-time data in wireless TCP/IP networks where accessible bandwidth is limited. This is particular relevant for IEEE 802.11b networks. For downstream data, the traffic shaper module can be set to control the transmission to all clients and thereby give priority to the port carrying real-time data. For the upstream case, data transmission from all kinds of standard devices is to be reduced or delayed. Hence, the data transmissions from other clients have to be controlled remotely from the access point. By delaying or discarding packets, such as TCP acknowledgements, to other clients, the traffic shaper module artificially increases their Round Trip Time (RTT). The protocol at these clients responds to the increased RTT by transmitting data at a lower rate, thereby leaving more bandwidth for the real-time data port.

The present invention relates to real-time streaming data, such as audio/video (A/V) stream transmissions, in wireless networks. In particular, the invention relates to protecting such real-time data against interfering data traffic to ensure uninterrupted streaming.

Present wireless network access systems typically have a limited bandwidth in the wireless link between access point and clients. Although a single client may experience a broadband connection, data bursts from other users on the same access point will momentarily interfere with the connection. This does typically not pose a problem when the broadband connection is used for normal data traffic. But, when the broadband connection transfers real-time data such as A/V streaming, data drop-outs due to bursts from other users will interfere with the streaming and should be avoided. There exist a number of different standards for wireless networks, where IEEE 802.11b is presently the most common. Further, there exist a number of communication protocols which can be used in wireless networks, and which apply the different standards.

US 2002/0075806 A1 discloses a data communication system and a method for preserving Quality of Service (QoS) throughout the system. The system needs to ensure that latency sensitive services such as voice and video conferencing receive guaranteed bandwidth, at the expense of other data such as Internet, file transfer, etc. The bandwidth is guaranteed by reserving timing slots in successive links through cascading networks in the system. The timing slots are timed so that a first time slot begins a short time before the successive time slot to make preparations for a fluent streaming though cascading networks.

The prior art realizes the problem of allocating more bandwidth to real-time data in wireless networks where the accessible bandwidth is limited. However, the prior art fails to point out detailed solutions to how the bandwidth is allocated in practice.

Streaming of A/V media content in an IEEE 802.11b wireless network may be problematic. Because the 802.11b standard merely defines a wireless Ethernet, without proper support for isochronous channels, other network traffic may easily interfere with the real-time data. Although 802.11b includes a channel reservation mode (RTS/CTS), this mode does not solve the above problem and it is optional, so that few products implement it. New QoS features are implemented in 802.11e, but are lacking in 802.11b.

It is an object of the present invention to provide a system and a method for allocating bandwidth to real-time data transmissions in wireless network protocols.

In a first aspect, the present invention provides a system for transmitting real-time data between an access point and one or more first clients in a wireless network, the system comprising:

an access point operating with a Transmission Control Protocol/Internet Protocol (TCP/IP) suite including the User Datagram Protocol (UDP),

two or more clients associated with the access point to form a wireless network, and

a traffic shaper module held by the access point for delaying the transmission of at least some packets from the access point to other clients than the one or more first clients, at least when real-time data is transmitted between the access point and a first client.

Preferably, the traffic shaper module comprises an element adapted to examine headers of packets to be transmitted from the access point and, if the packet is recognized as a TCP Acknowledgement, to delay the transmission of said TCP Acknowledgement (TCP ACK).

In a preferred embodiment, the traffic shaper module introduces appropriate delays in downstream TCP ACKs, when the non real-time data transmission is upstream that is, from interfering clients (other than first client) to the access point. This technique exploits the self-clocking TCP flow control mechanism, which is based on TCP ACK packets.

In another preferred embodiment, the traffic shaper module introduces delays in all downstream IP packets, which are not real-time traffic packets (TCP ACKs and data payload packets). Possibly, delays are introduced only in bandwidth demanding downstream IP packets such as payload packets.

The traffic shaper module is preferably a piece of software that is implemented in the network driver of the residential gateway, such as in the access point. It runs at the link layer in the protocol stack. The traffic shaper does preferably not modify the existing protocols, it just provides an added functionality.

The system preferably comprises a memory buffer adapted to temporarily storing the delayed packets. The memory buffer may be any memory available to the residential gateway and which can be appointed as memory buffer by the traffic shaper module.

In a second aspect, the present invention provides a method for transmitting real-time data between an access point operating with a TCP/IP suite including the UDP and one or more first clients in a wireless network by exploiting bandwidth made available using the following process step:

controlling data transmission between other clients in the wireless network and the access point to allocate a greater bandwidth to the one or more first clients, the step of controlling said traffic comprising the step of delaying the transmission of at least some TCP Acknowledgements from the access point to clients,

transmitting real-time data between the access point and a first client.

Optionally, non real-time downstream traffic from the access point to all clients may also be delayed.

In a third aspect, the present invention provides a method for controlling data transmission from clients in a wireless network to an access point of said wireless network, the access point and the clients operating with a TCP/IP suite including the UDP, the method comprising the steps of:

receiving downstream data packets at the access point from an external network or from an application in the residential gateway itself,

examine the headers of said packets to determine if a data packet is a TCP Acknowledgement to a client in the wireless network,

determining whether the available bandwidth for said client will be exceeded by upstream data packets from the client, and, if it will, delaying the transmission of said TCP Acknowledgement from the access point to the client.

In a fourth aspect, the present invention provides a record carrier comprising information which when loaded into or executed by a computer, performs one or more of the steps according to the second or third aspects.

In the present application, the term real-time data refers to data which is processed at the moment it enters a computer, as opposed to BATCH processing, where the information enters the system, is stored, and is operated on at a later time. Real-time data is also referred to as streaming media. Real-time data are typically streams such as live video or live voice transmissions. However, real-time streaming is also used when a large amount of external data (such as a movie clip stored at another PC) has to be viewed by a client. Instead of waiting for all data to be downloaded, the client starts viewing the data gradually as it arrives. Thus the data itself need not be real-time, it may be recorded long time ago. Interruptions in the transmissions means interruptions in the execution of the data (if the interruption goes beyond the buffer size) and is undesirable. Streaming is typically used for data with Audio/Video content because of their strict chronology which allows for the running execution, however, streaming can be used for other types of data as well.

An access point is a network device that interconnects a wireless network to a wired network. The wired network may be interconnected to other wireless networks so that the access point serves to interconnect two wireless networks. The access point is typically a dedicated network access device or a server such as a PC or a Residential Gateway (RG) with a communication protocol such as TCP/IP using a wireless IEEE 802.11 standard.

In the present application, clients are devices (or software) that request wireless communication with the access point. A client may be another server, a PC, a cellular phone, a Personal Digital Assistant (PDA), or any other device using a wireless communication protocol and having means for wireless transmission and receiving of data.

It is an advantage of the invention that it exploits the knowledge of existing wireless network communication protocols and does not introduce changes in the normal operation mode of the protocols, both at the MAC and transport layers, i.e. IEEE802.11b and TCP/IP protocol implementations are unchanged.

It is an advantage of a preferred embodiment of the invention that it improves the delivery of real-time streaming so that there is no need to install any new component at the clients, the invention can be used with any wireless client with a protocol having the appropriate standard responses.

It is an advantage of a preferred embodiment of the invention that it improves the delivery of real-time streaming content without the applications at any of the clients being aware of it, they simply experience an increased Round Trip Time.

It is an advantage of a preferred embodiment of the invention that it improves the delivery of real-time streaming content in wireless Ethernet media networks like IEEE802.11b, without making use of the channel reservation mode, which only few products implement and without modifications in the MAC operation.

The problem of allocating more bandwidth to real-time data in wireless networks where the accessible bandwidth is limited, may be divided into downstream and upstream cases. For the downstream non real-time streaming case, downstream data transmission to other clients should be delayed. Traffic shaper module can be set to control the transmission of data to all clients, and thereby to delay data to specific clients when a certain bandwidth is needed to a specific client. The upstream case, however, is more complicated. Here, data transmissions from all other clients but the real-time streaming one has to be controlled centrally. However, these clients may be all kinds of standard devices which may not have a traffic shaper module installed. Hence, the data transmissions from other clients have to be controlled remotely from the access point.

It is the basic idea of the invention that it exploits the knowledge of existing network communication protocols like TCP/IP. By delaying packets, such as TCP ACKs, to ports (clients) which are not used for real-time streaming, the traffic shaper in the access point:
1. Simulates a longer Round Trip Time (RTT). The TCP protocol at the clients responds to the increased RTT by holding the next packet to be sent until it receives the delayed TCP ACK, this goes for the following packets as well. In the sliding window flow control mechanism, it means that the window does not move to the next segment until the ACK is received. This reduces the transmission rate from the client and thereby leaves more bandwidth to the real-time data port.
2. Artificially increases the mean RTT and the RTT variance for these ports. The protocol at the clients responds to the increased RTT means and variance by increasing the retransmission timeout, whereby retransmissions are not sent as the TCP ACKs are delayed increasingly. This ensures that the timeout is gradually increased so that the client does not flood the wireless medium with retransmissions.

The protocol at the non-streaming client is a standard TCP protocol, which responds in a standard way to the delays created by the traffic shaper. Similarly, the delaying of packets and following reduction in transmission rate from an application at the non-streaming client happens without the application being aware of it. There is thus no need to install any component at the clients.

These and other aspects of the invention will be apparent from and elucidated with references to the embodiments described hereinafter.

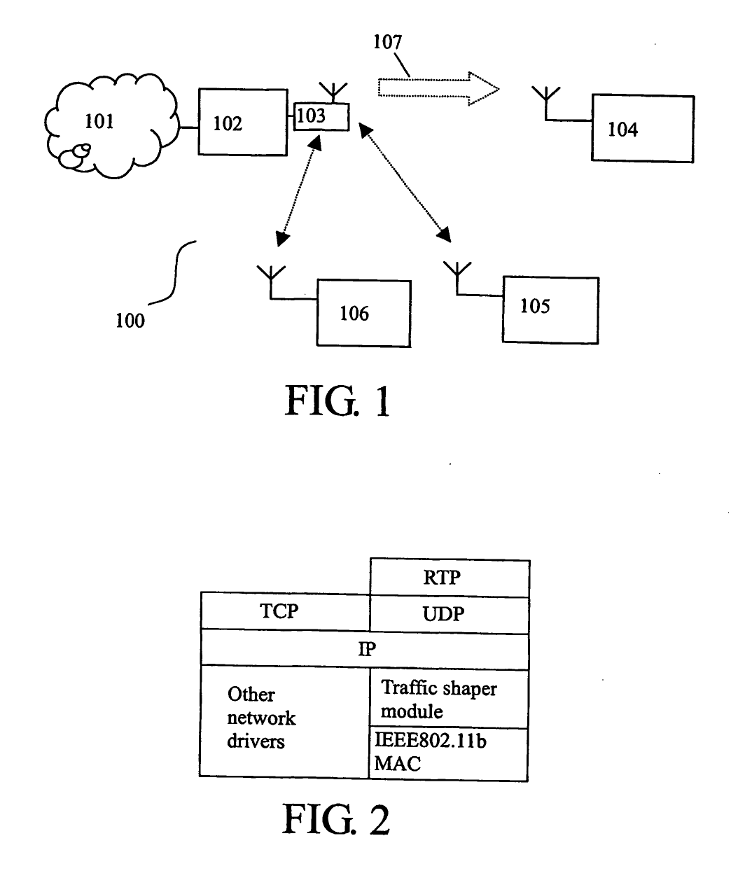

FIG. 1 shows a wireless network with access point and a plurality of clients.

FIG. 2 is an illustration giving the position of the traffic shaper according to the invention in the server protocol stack.

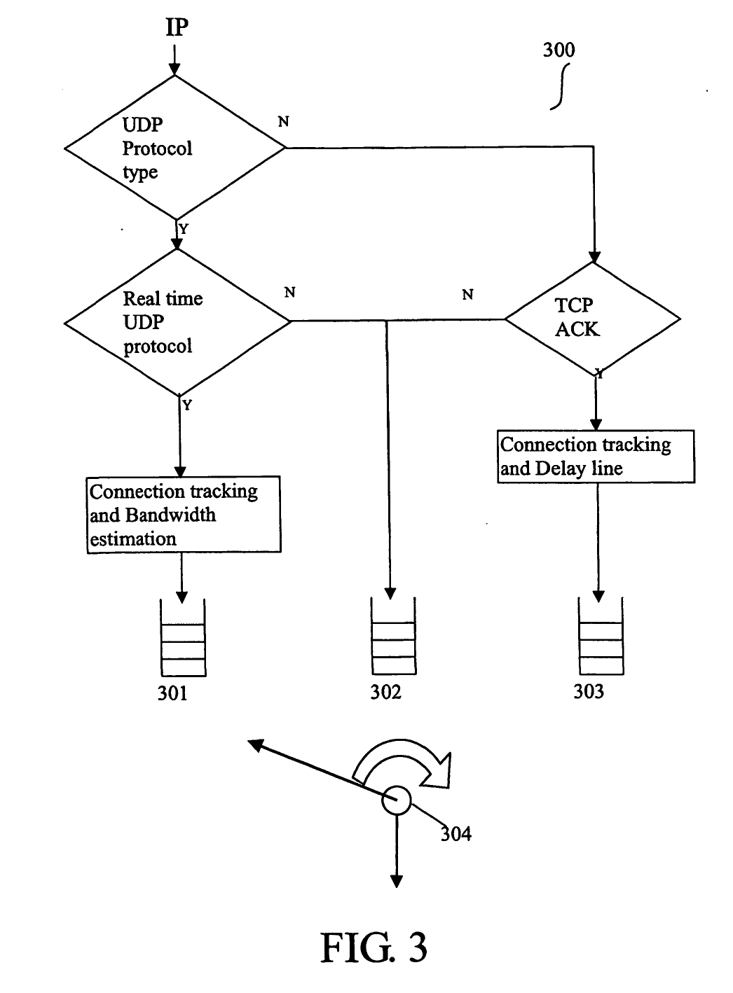

FIG. 3 is a flow chart demonstrating the procedure for deciding which packets to be delayed.

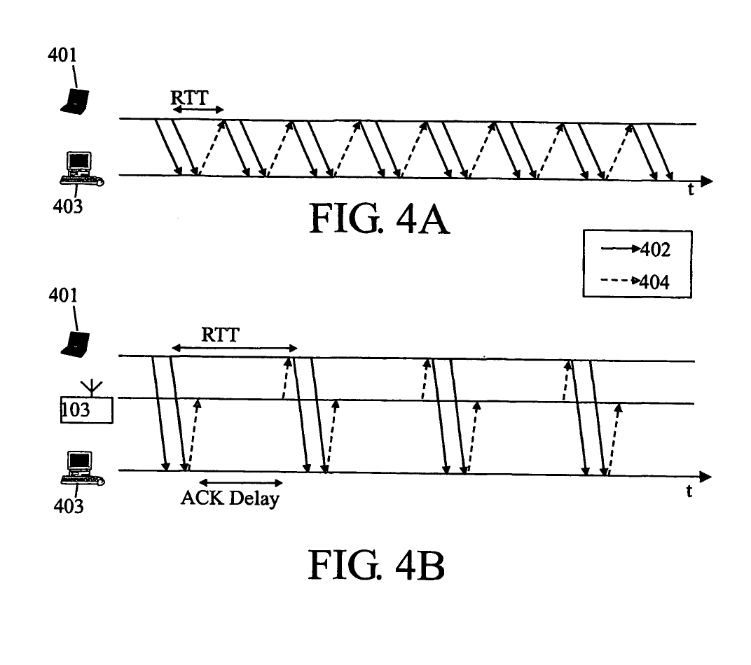

FIG. 4A is an illustration of the packet flow in prior art systems. FIG. 4B is and illustration of the introduced delay of the TCP ACK signals according to the invention.

In a preferred embodiment of the invention shown in FIG. 1, a network access server 102 having an access point 103, and a plurality of clients 104, 105, and 106 forms a wireless network 100 being connected to the internet 101. The access server and the access point can be one integrated device, and are therefore referred to interchangeably. The wireless network operates under the TCP/IP, uses the IEEE 802.11b standard, and is configured either in infrastructure mode or in ad-hoc mode. Real-time data 107 is to be transmitted between the access point 103 and client 104 (either from the access point to the client or in the opposite direction). In the following sections, the invention will be described in relation to this preferred embodiment. This should not indicate that the specific elements in this preferred embodiment are essential to the invention, and should not be interpret as limiting the scope of the invention.

The present invention provides a method for controlling the upstream data transmissions from clients 105 and 106 to the access point 103 so as to reserve upstream bandwidth to ports with upstream real-time data. Thus, the invention controls upstream data transmissions by interfering with downstream data transmissions.

The present invention can also provide delay for downstream data packets without urgent streaming content to reserve downstream bandwidth to ports with downstream real-time data. The traffic shaper according to the invention can perform this function by looking at the available bandwidth (=the total bandwidth minus the required bandwidth for the streaming port minus MAC overhead bandwidth) and the size of incoming downstream data packets. If the rate of the downstream data packets exceeds the momentarily available bandwidth, the packets should be delayed or discarded. The controlling of downstream data to reserve downstream bandwidth is a simple task, which is performed by the traffic shaper without the need of dedicated signaling protocols.

In the present description, if a data packet is said not to be delayed, it is meant that it is not to be delayed with the purpose of controlling upstream data transmission from clients 105 and 106 to access point 103. The same data packet may, however, be delayed with the purpose of controlling downstream data transmission from access point 103 to clients 105 and 106.

The traffic shaper module is a pack of software that is stored on the network access server 102 also holding the network driver of the IEEE 802.11b card and the TCP/IP protocol. FIG. 2 shows the position of the traffic shaper module in the protocol stack. The traffic shaper can be implemented as a virtual device driver, which exchanges data packets between the TCP/UDP/IP stack and an existing wireless network driver. The traffic shaper module therefore runs at the link layer and it exploits the knowledge of TCP flow control algorithm. In order to do so, it needs to examine all the packets it receives (in upstream and in downstream) and look at the header fields, if traffic is not encrypted. Upstream packets are received by the lower layer wireless network driver and can be used to determine if a specific wireless client has an ongoing data transfer in place or is starting a new one. Downstream packets are received at the traffic shaper from the upper layers (either the IP stack or a bridge module) and are transmitted either immediately or after a specified delay, or discarded in case of redundant network protocols like ARP of other broadcast traffic. In the simplest case, the packets are sent in clear and the traffic shaper can examine the header fields directly, in order to recognize for example TCP ACKs. In case of encrypted packets, the traffic shaper may try to recognize the TCP ACKs by looking at the frame size and at the unencrypted parts of the header.

A flow chart 300 for the packet-processing algorithm of the traffic shaper module is shown in FIG. 3. Downstream Packets to be transmitted are sorted and buffered in separate queues 301, 302, 303 with different priorities, depending on the flow the packet belongs to; real-time streaming packets, other data packets, or TCP ACK.

In order to sort packets, the protocol type of the IP packet is first checked. If the protocol type is UDP there is a good chance that it is a real time traffic packet. A further check of the source UDP port against well known real time streaming ports will reveal whether we are dealing with “urgent” packet or not. If the packet is recognized as urgent real-time data, another operation needs to be performed by the traffic shaper, it needs to track and store the bandwidth required by currently used streaming applications. This information is then used to know how much bandwidth is available for non real-time TCP applications and manage resources efficiently. If the IP packet is not UDP type, we check whether it is a TCP ACK. ACKs are easily recognized because usually they do not carry payload at all and have the “ACK” field set. If we are dealing with a TCP ACK, we have to identify the TCP connection it belongs to (similar to what we do with UDP traffic) in order to calculate the delay we are going to apply to the packet. Delays are computed according to the available bandwidth we have (i.e. link's bandwidth minus the bandwidth consumed by real-time data applications minus MAC overhead) and depend of course on the size of the upstream IP packets. Upstream packet sizes are known at the MAC layer and are made available by the wireless network driver.

If the traffic is encrypted the sorting operation can be more complicated. If the Secure Socket Layer (SSL) mechanism is used, which is a typical case for secure Internet transactions, the TCP/IP packet headers are sent in clear and the traffic shaper can easily recognize TCP ACKs. If network layer security is applied instead (for example when a Virtual Private Network is used), then the TCP header is encrypted. In this case, the traffic shaper can only examine the IP header to filter the packets that are directed to a certain slave. The traffic shaper may choose to delay all the packets with the exception of those belonging to the A/V stream, by an amount of time Δ(B), which depends on the bandwidth B reserved for streaming.

The queues are: a high priority queue 301 for real-time data, a normal priority queue 302 for downstream data packet, and a low priority queue 303 for TCP ACKs. Naturally, other queues can be made under the working principle of the present invention. A scheduler 304 empties the queues according to a policy that takes the queue priorities into account. An example of such a policy is Weighted Round Robin (WRR), but many other scheduling algorithms can be found in literature. With WRR, each queue gets polled by the scheduler 304 with a frequency that is proportional to the queue priority and, if at least one packet is buffered, it is dequeued for transmission. A possible alternative to WRR is the so-called Earliest Deadline First (EDF) scheduling policy. Using EDF, each packet to be transmitted is tagged with a timestamp when it is queued. When deciding which packet to transmit, the scheduler 304 searches each queue for the packet with the most urgent timestamp indication. In this case, the classification function of the traffic shaper module, that discriminates traffic flows, needs to assign such timestamps properly.

FIGS. 4A and B gives a detailed illustration of the working principle of the present invention. FIG. 4A shows the signal flow using a TCP without the traffic shaper according to the invention. In FIG. 4A, when a client 401 sends data segments 402 to a server 403, it expects the destination server 403 to respond with a TCP ACK 404 whenever it successfully receives segment 402. Every time the client sends a segment, it starts a timer and waits for the TCP ACK. If the timer expires (timeout) before the corresponding TCP ACK, TCP assumes that the packet was lost or corrupted and retransmits it. Retransmission timeout is preferably set so that packets are not retransmitted every time they experience delays in their path (or in the ACK path). On the other hand, if the timeout is too long, re-establishment of lost data will be too slow. In TCP/IP, the continuing calculation of the timeout is based on algorithms applying both the variance and the mean of the RTT.

FIG. 4B shows the signal flow using a TCP with the traffic shaper module according to the invention. The module exploits the TCP ACK timing procedures of TCP/IP to indirectly control the transmissions from the client. The TCP ACK timing is described in J. Border et al., Performance Enhancing Proxies Intended to Mitigate Link-Related Degradations, RFC3135, IETF PILC WG. In FIG. 4B, when a client 401 sends data segments 402 to a server 403, these are not delayed by the access point 103. If another client is transmitting real-time data, the ACK 404 from server 403 to client 401 will be recognized as a TCP ACK by the traffic shaper module according to the procedure described in relation to FIG. 3. If delay of the ACK is required in order to secure upstream bandwidth, the ACK is delayed a specified time, ACK Delay. The RTT is prolonged correspondingly. During the delay, the ACK frame is stored in a buffer at the access point. When delaying the ACK, it is important not to make the ACK Delay so long as for the RTT to exceed the timeout, as this would generate uncontrollable upstream data. Therefore, the ACK Delay should be determined with attention to the timeout calculation at the client's TCP. Issues related to the RTT and retransmission timeout calculations can be found in e.g. Douglas E. Comer, Internetworking with TCP/IP, vol. I, 3rd edition, Prentice-Hall, 1995, ISBN 0-13-216987-8.

The time delay to be applied to TCP ACKs can be calculated according to several algorithms. Below we give an example of a simple algorithm that can be used for the purpose of the present invention. Assuming a wireless network which downstreams real-time data and with only a single interfering TCP connection, with constant packet size, TCP window saturated and a regular flow of ACK packets, we define:
T_{ACK} as the interarrival time of TCP ACK packets
Δ_{ACK} the delay to be applied
B_{TCP} the measured average bandwidth consumed by the TCP connection
B′_{TCP} the desired target bandwidth for the TCP connection (=Bₜₒₜₐₗ−B_{real-time stream})
T′_{ACK}=T_{ACK}+Δ_{ACK} the new TCP ACK interarrival time.
It is easily observed that:
T_{ACK}B_{TCP}=(T_{ACK}+Δ_{ACK})B′_{TCP} (1)
which brings:

$${Δ}_{ACK} = ( \frac{{B}_{TCP}}{{B}_{TCP}^{′}} - 1 ) {T}_{ACK} \qquad ( 2 )$$

It should be noted, however, that the new TCP ACK interarrival time should not exceed the TCP retransmission timeout timer (typical values are 200-250 ms), which would usually trigger packet retransmissions and wireless bandwidth waste.

T_{ACK} can be measured by the access point by calculating a running average of interarrival times between consecutive ACK packets. B_{TCP} can be easily derived by the access point by measuring the traffic that the client is generating (such statistics are always collected by the WLAN hardware and made available by the wireless network driver). The target TCP bandwidth B′_{TCP} should be calculated to free enough bandwidth for the real-time streaming connection. It should also be noted that this bandwidth corresponds to “goodput”, meaning that wireless channel conditions have to be taken into account. In fact, errors on transmitted packets generate retransmissions and therefore more bandwidth is wasted and this should be taken into account. The access point knows enough information about the wireless channel conditions, since it can measure the Signal to Noise Ratio for each connected client.

The proposed algorithm is stable because TCP ACK packets will accumulate in the access point buffer only initially. After a period of time equal to the round-trip time, TCP will automatically lower its transmission rate and TCP ACKs will be generated at a slower pace without the buffer eventually overflowing.

The above strategy is only one of several possible techniques to calculate the TCP ACK delay for the purpose of reducing the traffic generated by clients in the wireless network. For example, in the case of multiple interfering TCP connections, the above algorithm can be adapted so that the overall bandwidth dedicated to TCP connections is reduced. One could either run an instance of the above algorithm for each connection (which may be resource consuming) or aggregate all TCP flows as a single connection.

For bursty TCP traffic the algorithm is automatically activated whenever the TCP ACK arrival frequency exceeds a predetermined threshold. In other words, the delay calculated in (2) is applied only when TCP ACKs arrive at intervals less than T′_{ACK}.

The algorithm can also be effective when clients in the same wireless network want to communicate with each other. For example in FIG. 1, if client 104 wants to exchange real-time data with client 106 with the IEEE802.11b configured in infrastructure mode, it sends a frame to the access point 103 and then the frame is forwarded to client 106 by a bridge. This means that the traffic shaper also intercepts traffic between clients and can delay it at will, if needed.

In the present application, the term “comprising” does not exclude other elements or steps. Neither do the terms “a” or “an” exclude a plurality.

1. A system for transmitting real-time data between an access point and one or more first clients in a wireless network, the system comprising:
an access point operating with a Transmission Control Protocol/Internet Protocol suite including the User Datagram Protocol,
two or more clients associated with the access point to form a wireless network, and
a traffic shaper module held by the access point for delaying the transmission of at least some packets from the access point to other clients than the one or more first clients, at least when real-time data is transmitted between the access point and a first client.

2. A system according to claim 1, wherein the traffic shaper module forms part of the network interface layer in the TCP/IP protocol stack.

3. A system according to claim 1, wherein the traffic shaper module comprises elements adapted to examine a header of packets to be transmitted from the access point and, if the packet is recognized as real-time data one of the one or more first clients, not to delay the transmission of said real-time data.

4. A system according to claim 1, wherein the traffic shaper module comprises an element adapted to examine headers of packets to be transmitted from the access point and, if the packet is recognized as a TCP Acknowledgement to another client than the one or more first clients, to delay or discard the transmission of said TCP Acknowledgement.

5. A method for transmitting real-time data between an access point operating with a Transmission Control Protocol/Internet Protocol suite including the User Datagram Protocol and one or more first clients in a wireless network, the method comprising the steps of:
controlling data transmission between other clients in the wireless network and the access point to allocate a greater bandwidth to the one or more first clients, the step of controlling said traffic comprising the step of delaying or discarding the transmission of at least some TCP Acknowledgements from the access point to other clients,
transmitting real-time data between the access point and a first client.

6. A method for controlling data transmission from clients in a wireless network to an access point of said wireless network, the access point and the clients operating with a Transmission Control Protocol/Internet Protocol suite including the User Datagram Protocol, the method comprising the steps of:
receiving downstream data packets at the access point,
examine the headers of said packets to determine if a data packet is a TCP Acknowledgement to a client in the wireless network,
determining whether the available bandwidth for said client will be exceeded by upstream data packets from the client, and, if it will, delaying the transmission of said TCP Acknowledgement from the access point to the client.

7. A record carrier comprising information which when loaded into or executed by a computer, performs one or more of the steps according to claim 5.
